(19) United States
(12) Patent Application Publication
(10) Pub. No.: US 2007/0249403 A1
(43) Pub. Date: Oct. 25, 2007

(54) Method and apparatus for Wi-Fi capacity enhancement

(75) Inventors: Shiwei Gao, Nepean (CA); Hafedh Trigui, Ottawa (CA)

Correspondence Address: Lawrence G. Kurland, Esq.;BRYAN CAVE LLP, 1290 Avenue of the Americas, New York, NY, 10104-3300, US

(73) Assignee: TenXc Wireless Inc.

(21) Appl. No.: 11/784,089

(22) Filed: Apr. 4, 2007

(30) Foreign Application Priority Data
Apr. 4, 2006 (CA) 2,547,648

(51) Int. Cl. H04M 1/00

(52) U.S. Cl. 455/562.1

(57) ABSTRACT

A novel system is disclosed for WLAN applications. The inventive system mitigates the problem of interference by overlaying an omni-directional pattern with a plurality of directional beams, where each beam covers only part of the serving area defined by the omni-directional pattern. After an initial communication from the subscriber stations along the omni-directional pattern, the directional beam that provides the best signal quality is determined and the access point thereafter communicates with that subscriber station using only the beam with the best signal quality. The inventive concept can be expanded to encompass MIMO WLAN systems.

### FIELD OF THE INVENTION

The present invention relates to communication in a WLAN (Wireless Local Area Network) system from the access point, more particularly it relates to WLAN communication using multiple beams.

### BACKGROUND TO THE INVENTION

WLAN is the name sometimes given to the 802.11 wireless telecommunications standard developed by the IEEE. It was intended to be used for wireless communications between portable devices and a local real network. It enables a person with a WLAN-enabled computer or personal digital assistant (PDA) to connect to the Internet when in proximity to an access point (AP). The geographical region covered by one or several access points is typically referred to as a hotspot. WLAN is also referred to as wi-Fi, is the name of an industry consortium that certifies WLAN systems.

A typical Wi-Fi hotspot contains one or more Access Points (APs) and one or more clients, also referred to as subscriber stations (SS). An AP broadcasts its Service Set Identifier (SSID) and other system configuration information via packets that are called beacons, which are broadcasted periodically. Based on the received information, the client may decide whether to connect to an AP. The Wi-Fi standard leaves connection criteria and roaming totally open to the client.

In the current systems, an omni-directional antenna is typically used in both the APs and the clients. The number of active clients that an AP can support is limited by the CSMA/CA access protocol used in the WLAN system. If too many clients try to access the AP, collisions may happen more frequently and thus there is less opportunity to communicate to the AP. The coverage range of the AP is typically determined by the AP's Equivalent Isotropic Radiated Power (EIRP), the propagation loss and the client's receive sensitivity.

For a particular WLAN client, its communication data range is determined by the received signal quality at both the client and the AP ends. The signal quality is affected by both receiver noise and interference from neighbouring systems operating in the same or adjacent frequency channels. This is particularly true for the Wi-Fi standard 802.11b/g systems, due to the very limited number of non-overlapping channels.

### SUMMARY OF THE INVENTION

The present invention mitigates the interference problem by overlaying the coverage area with multiple directional antenna beams, where each beam covers one part of the serving area. At any given time, only one beam is active between an AP and a SS.

Tho system could be implemented as an applique system, where the system comprises components that could be added to an existing system in order to improve performance.

In a preferred embodiment the system consists of a multi-beam antenna and associated intelligent beam selection hardware and software. After an initial broadcast using the omni-directional antenna and handshaking with the subscriber station, which involves determining the directional beam that provides the best signal quality an AP thereafter communicates to each client SS with only the beam with the best signal quality. As a result, the highest communication data rate is achieved between the AP and the desired SS while any interference to and from the AP outside the beam coverage is eliminated or substantially reduced.

In accordance with a first broad aspect of the present invention there is disclosed a method of communicating data between a subscriber station in a Wi-Fi broadcast area and an access point associated with the broadcast area, comprising the steps of:
a. overlapping the broadcast area with a plurality of directional beams and an omni-directional beam;
b. associating the subscriber station with one of the plurality of directional beams from signals received at the omni-directional beam and the plurality of directional beams; and
c. communicating data between the subscriber station and the access point along the associated directional beam.

In accordance with a second broad aspect of the present invention there is disclosed a Wi-Fi access point having an associated broadcast area, comprising:

a multi-beam antenna for communicating with a subscriber station within the broadcast area, comprising an omni-directional beam and a plurality of directional beams; and

an access point controller coupled to the multi-beam antenna for selecting a directional antenna beam for communicating with the subscriber station.

### BRIEF DESCRIPTION OF THE DRAWINGS

FIG. 1 is a block diagram of an exemplary embodiment of the present invention in integrated form.

FIG. 2 is an exemplary beam pattern diagram illustrating a beam pattern generated by the embodiment of FIG. 1.

FIG. 3 is a signal flow diagram showing communications between the AP and the SS in accordance with the embodiment of FIG. 1.

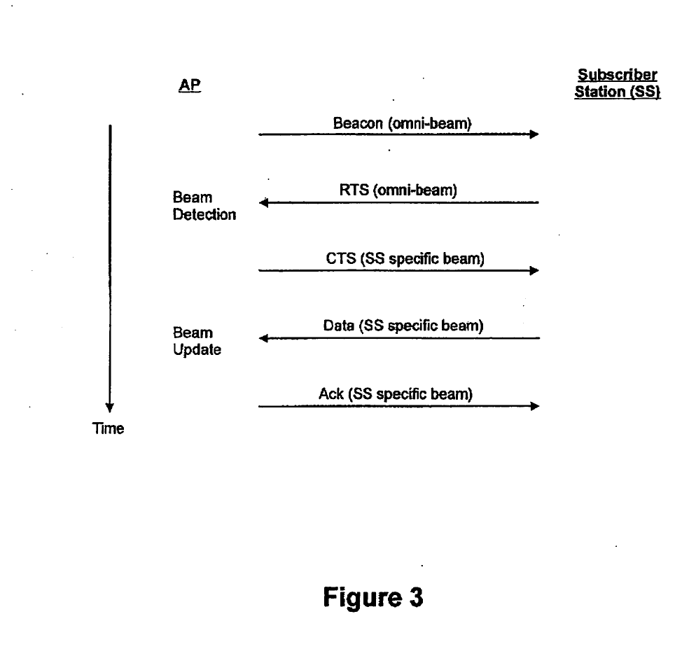

### DETAILED DESCRIPTION

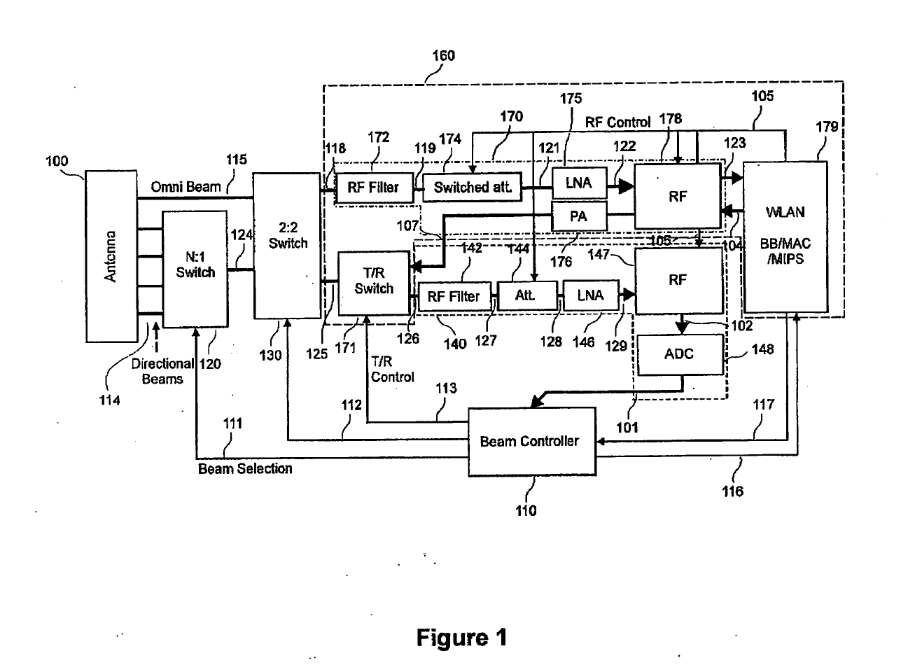

FIG. 1 shows a block diagram of an exemplary embodiment of the present invention as a system solution.

The system comprises a multiple-beam antenna 100, a plurality of beam switches 120, a 2:2 switch 130, an RF filter 142, a switched attenuator 144, a low-noise amplifier 146, an RF circuit 147, an analog to digital converter (ADC) 148, a beam controller 110, a transmit/receive (T/R) switch 171, an RF Filter 172, a switched attenuator 174, a low noise amplifier (LNA) 175, power amplifier 176, an RF integrated circuit 178, and a Wireless Local Area Network (WLAN) processor 170.

The multi-beam antenna 100 comprises an omni-directional antenna and a plurality of directional antennas. It is connected through a plurality of signals 114, to the beam switches 120. The multi-beam antenna 100 is also connected to the 2:2 switch 130 through an omni-directional beam signal 115.

The beam switches 120 are connected to the 2:2 switch 130 through a signal 124. Furthermore they receive control signals from the beam controller 110, through a beam selection signal 111,

The 2:2 switch 130 is connected to the RF filter 172 of a communication signal processor 160 by signal 118. It is also connected to the transmit/receive switch 171 through signal 125, and it receives a switch control signal 112 from the beam controller 110.

The RF filter 172 of the communication signal processor 160 is connected to the switched attenuator 174 through signal 119.

The switched attenuator 174 is connected to the low noise amplifier 175 through a signal 121. It also receives control signals from the WLAN processor 179 through an RF control signal 105.

The low-noise amplifier 175 is connected to the RF circuit 178 through a signal 122.

The RF circuit 178 is sends information to the WLAN processor 179 through signal 123, and receives information through signal 104. It also receives control signals from the WLAN processor 179 through RF control signal 105. Additionally it is connected to the power amplifier 176 through signal 106.

The WLAN processor 179 sends control signals to the beam controller 110 through the antenna control signal 117, and receives a best bean selection signal 116, from the beam controller 110.

The power amplifier 176 Is connected to the transmit/receive switch 171 through signal 107.

The transmit/receive switch 171 is connected to the RF filter 142, though signal 126. It furthermore receives the transmit/receive control signal 113 from the beam controller 110.

The RF filter 142 is connected to the switched attenuator 144 through signal 127.

The switched attenuator 144 is connected to the low-noise amplifier 146 through signal 128. It also receives control signals from the WLAN processor 179 through RF control signal 105.

The low-noise amplifier 146 is connected to the RF circuit 147 through signal 120.

The RF circuit 147 is connected to the analog to digital converter (ADC) 148 through signal 102. It also receives control signals from the WLAN processor 179 through RF control signal 105.

The ADC 140 is connected to the beam controller 110 through signal 101.

In an exemplary embodiment, the multiple-beam antenna 100 consists of a plurality of antennas, each corresponding to a single beam pattern. One of the antennas included in this multi-beam structure is omni-directional, while the remaining provide directional beam patterns.

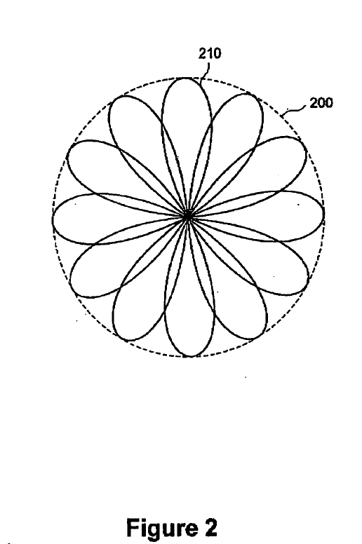

In FIG. 2, an exemplary beam pattern diagram of the provided antenna coverage is shown. The multi-beam antenna provides one omni-directional beam 200 and multiple directional beams 210 covering a 360-degree area.

Those having ordinary skill in the art will readily recognize that the multi-beam antenna 100 could be implemented in a number of ways. For example, an array antenna could be used in combination with beamforming to form the individual directional beams.

The beam switches 120 are used to select one of the directional beams. In the exemplary embodiment the beam switches 120, are implemented as a N:1 RF switch.

The 2:2 switch 130 is used to select between two paths. In the first the omni-directional signal 115 is passed through to the RF filter 172, while simultaneously the selected directional signal 124 is passed to the T/R switch 171. In the second path, the omni-directional signal 115 is passed through to the T/R switch 171, while simultaneously the selected directional signal 124 is passed to the RF filter 172. In the exemplary embodiment the 2:2 switch 130 is implemented as a 2:2 Double Pole, Double Throw (DPDT) switch.

The RF filters 172, 142, are designed so that their pass band covers the operational frequency band.

The switched attenuators 174, 144, are used to allow the system to operate in the full dynamic range defined by the 802.11 standards. More than one attenuator may be used at 2.4 GHZ. The attenuators 174, 144 scale down the signal so that the signal would not cause saturation of the system's circuitry.

The low noise amplifiers 175, 146, are used to increase the received signal strength.

The RF circuits 178, 147, are used to down convert the received signal from RF to baseband in-phase and quadrature (I&Q) signals.

The power amplifier 176, is used to increase the signal strength of transmitted signals.

The transmit/receive switch 171, is used to switch between transmission and reception.

The analog to digital converter 148 is used to digitize the I&Q signals and then to send the digital signal to the beam controller 110 for further processing. In the exemplary embodiment two analog-to-digital converters (ADC) 148 are used to digitize the I&Q signals.

The WLAN processor 179 is a slightly modified conventional WLAN processor. The application layer functions are modified to allow the best beam number 116 from the beam controller 110 to be uploaded for each newly received frame, and to update a beam switching table (BST) with each frame. Furthermore for each packet transmitted, the WL processor 179 will examine the beam switching table to determine the best antenna number 117 for the particular Media Access Control (MAC) address, and then add this information to the packet header to be transmitted.

The beam controller 110 performs a variety of functions. It acts as a relay for control signals coming from the WLAN processor to alter the T/R switch 171, and beam switches 120. It provides beam scanning control while processing Request to Send (RTS) signals from a subscriber station (SS). It provides channel filtering and signal quality estimation, selects the best receiver (Rx) beam number 116 based on the signal quality estimation, and then forwards this selection to the WLAN processor 179 before the end of the Rx frame.

Those having ordinary skill in the art will readily recognize that the beam controller 110 could be implemented in a number of ways. For example, a field programmable gate array (FPGA), digital signal processor (DSF), or a microprocessor could be programmed with the functionality described.

In operation, the multi-beam antenna 100 receives an RF signal from a subscriber station (SS) through the omni-directional antenna. The signal received is sent 115 to the 2:2 switch 130. The 2:2 switch 130 is initially configured to transmit this signal through signal 118 to the RF filter 172.

The received signal 118 is then filtered and forwarded 119 to the switched attenuator 174.

The switched attenuator 179 attenuates the signal and forwards 121 it to the amplifier 175.

The low noise amplifier 175 then amplifies the signal and forwards 122 it to the RF circuit 178.

The RF circuit 178 brings the signal down to baseband and sends it 123 to the WLAN processor 179.

While this is happening with the omni-directional beam 11S, the directional antennas are also receiving signals 114.

The beam controller 110 is in receive mode and recognizes that a signal (such as an RTS) is being received through the directional antennas of the multi-beam antenna 100.

The received signals from the directional beams 114 enter the beam switches 120, and the beam controller selects 111 a signal to pass through to the 2:2 switch 130,

The 2:2 switch 130 sends the selected directional signal 124 to the T/R switch 171 through signal 125.

The T/R switch 171 is configured to send the signal 125 to the RF filter 142.

The RF filter 142 filters the signal 126 and sends it to the switched attenuator 144.

The switched attenuator 144 attenuates the signal 127 and sends it to a low-noise amplifier 146.

The amplifier 146 amplifies the signal 128 and sends it to the directional RF circuit 147.

The RF circuit 147 brings the signal 129 down to baseband and sends it to the ADC 148.

The ADC 148 digitizes the signal 102 and sends it to the beam controller 110.

The beam controller 110 receives the digital signal 101, and processes it to determine the signal strength. This process continues for the other directional beams 114, until the beam controller 110 can select the best beam number 116. The beam controller 110 then sends the best beam number 116 to the WLAN processor 179.

The WLAN processor 179 processes the received omni-directional signal 123, and receives the best beam number 116 from the beam controller 110. The source subscriber's ID (e.g. Media Access Control (MAC) or Connection Identification (CID)) is identified from the received omni-directional burst 123. A beam switching table is established and a new entry is added. An example of the beam switching table is shown as Table 1. The subscriber station ID number is correlated with the best beam number 116, and with a subscriber station's status value.

The status in this case is denoted as a “1” for an active station, and a “0” for an inactive station. When a subscriber station (SS) is inactive for a predefined period of time, the corresponding entry in the table is removed.

TABLE 1
Beam switching table (BST)

| Subscriber Station ID | Beam Number | Status |
|---|---|---|
| #1 | 4 | 1 |
| #2 | 2 | 0 |
| . . . | | |

The WLAN processor 179 then sends the response signal 104 to the RF circuit 178 and sends the antenna control signal 117 to the beam controller 110.

The RF circuit 178 converts the signal up to the transmission frequency and Forwards it to the power amplifier 176.

The power amplifier receives the signal 106 and amplifies it, and then forwards it to the T/R switch 171.

At the same time, the beam controller 110 receives the antenna control signal 117, and then sends out a transmit/receive signal 113 to the T/R switch 117, a switch control signal 112 to the 2:2 switch 130 and a beam selection signal 111 to the beam switches 120.

The T/R switch 171 has now been configured to transmit through the T/R control signal 113. The transmit data signal 107 is received and then forwarded to the 2:2 switch 130.

The 2:2 switch 130 has been configured by the switch control signal 112 to pass the received signal 125 over to the beam switches 120 through signal 124.

The beam switches 110 receive the transmit signal data 124, and have now been configured to transmit the signal through the selected antenna by the beam selection signal 111.

The signal is then transmitted to the subscriber station through the selected best beam. At the next allotted time to receive data from the subscriber station the selected best beam is configured to receive data.

The system monitors the signal quality during packet reception and selects the beam with the best signal strength. Over time this process builds up the beam switching table and the subscriber station to beam mapping is learned. Before each packet transmission, the best beam is identified by referencing the mapping table and the beam is used for subsequent packet transmission to the subscriber station (SS).

When the access point (AP) is expecting a packet from a particular subscriber station (SS) during a reception time, the corresponding beam is identified by looking up the subscriber station address in the beam switching table (BST).

Subscriber stations (SS) may move from one location to anothcr from time to time. The subscriber station (SS) location is tracked using post-processing methods such as correlation of multiple beam selection decisions over time.

The start of a transmission (Tx) time period is identified by monitoring the T/R switch control signal 113 from the beam controller 110. The destination subscriber station (SS) of the packet to be transmitted needs to be obtained from the WLAN processor 179 before the start of the transmission. The beam used for the packet transmission is identified by looking up the subscriber station ED number in the beam switching table (BST). If the subscriber station (SS) cannot be found in the table or the packet is a multicast/broadcast packet, an omni-directional beam pattern is used for the transmission and the 2:2 switch 130 is configured for the second path.

Table 2 is a summary of the mapping between some packet types and the beams used by the access point (AP) to receive and transmit the packets.

TABLE 2
Beam Assignment

| Packet Type | Beam Type |
|---|---|
| Request to Send (RTS) (unknown | Omni |
| SS) | |
| Request to Send (RTS) (known SS) | SS specific beam |
| Clear to Send (CTS) | SS specific beam |
| Acknowledge (ACK) | SS specific beam |
| Power Save Poll (PS-Poll) | SS specific beam |
| Data | SS specific beam |
| Beacon | Omni |
| Association response | SS specific beam |
| Disassociation | SS specific beam |
| Re-association response | SS specific beam |
| Probe Response | SS specific beam |
| Authentication | SS specific beam |
| De-authentication | SS specific beam |

Those having ordinary skill in the art will recognize that the RF filter 172, switched attenuator 174, low-noise amplifier 175, and RF circuit 178 could be referred to as an RF front end 140. Furthermore the person of ordinary skill in the art will recognize that this could be implemented in any number of ways.

Also those having ordinary skill in the art will recognize that the transmit/receive switch 171, RF front end 140, and Wireless Local Area Network (WLAN) processor 179 could be referred to as a communications signal processor 170.

Other embodiments consistent with the present invention will become apparent from consideration of the specification and the practice of the invention disclosed therein.

Accordingly, the specification and the embodiments are to be considered exemplary only, with a true scope and spirit of the invention being disclosed by the following claims.

The embodiments of the present invention for which an exclusive property or privilege is claimed are:

1. A method of communicating data between a subscriber station in a Wi-Fi broadcast area and an access point associated with the broadcast area, comprising the steps of:
d. overlapping the broadcast area with a plurality of directional beams and an omni-directional beam;
e. associating the subscriber station with one of the plurality of directional beams from signals received at the omni-directional beam and the plurality of directional beams; and
f. communicating data between the subscriber station and the access point along the associated directional beam.

2. A method according to claim 1, wherein the step of associating comprises selecting one of the plurality of directional beams for which a quality of the signals received from the subscriber station is a maximum.

3. A method according to claim 2, wherein the step of associating comprises broadcasting an identifying signal throughout the broadcast area using the omni-directional antenna.

4. A method according to claim 3, wherein the step of broadcasting comprises broadcasting a beacon.

5. A method according to claim 3, wherein the step of associating comprises receiving an identifying response to the identifying signal from the subscriber station.

6. A method according to claim 5, wherein the step of associating comprises measuring a signal strength of the identifying response along each of the plurality of directional beams.

7. A method according to claim 2, wherein the step of associating comprises recording the associated directional beam.

8. A method according to claim 7, wherein the step of recording comprises storing an identification number associated with the subscriber station.

9. A method according to claim 7, wherein the step of recording comprises storing the associated directional beam number.

10. A method according to claim 7, wherein the step of recording comprises storing a status of the associated directional beam.

11. A Wi-Fi access point having an associated broadcast area, comprising:
a multi-beam antenna for communicating with a subscriber station within the broadcast area, comprising an omni-directional beam and a plurality of directional beams; and
an access point controller coupled to the multi-beam antenna for selecting a directional antenna beam for communicating with the subscriber station.

12. A Wi-Fi access point according to claim 11, wherein the access point controller comprises a beam switch coupled to the multi-beam antenna for controlling the selection of a beam thereof.

13. A Wi-Fi access point according to claim 12, wherein the access point controller comprises an RF front end coupled to the beam switch for processing signals between the access point and the subscriber station.

14. A Wi-Fi access point according to claim 13, wherein the RF front end comprises an RF filter coupled to the beam switch for reducing noise in the signals.

15. A Wi-Fi access point according to claim 13, wherein the RF front end comprises an amplifier for boosting the signals.

16. A Wi-Fi access point according to claim 12, further comprising a beam controller coupled to the access point controller for selecting the selected directional beam for communication with the subscriber station, and for notifying the beam switch of the selected beam.

17. A Wi-Fi access point according to claim 16, wherein the access point controller comprises a WLAN processor for maintaining a directory associating a subscriber station with a directional beam and coupled to the beam controller for exchanging directory information.
